(19) United States
(12) Patent Application Publication
(10) Pub. No.: US 2025/0200610 A1
(43) Pub. Date: Jun. 19, 2025

(54) CREATIVE GATEWAY

(71) Applicant: NBCUniversal Media, LLC, New York, NY (US)

(72) Inventors: Alexandra Posner, New York, NY (US); Natasha Thandi, Elmont, NY (US); Michael Levin, Westfield, NJ (US); Caitlin Murphy, Bloomfield, NJ (US); Abigail Lord, New York, NY (US); Anthony Cristiani, Red Bank, NJ (US); Ofir Dassa, Miami Beach, FL (US); Jake McAreavy, Wheat Ridge, CO (US)

(21) Appl. No.: 18/538,643

(22) Filed: Dec. 13, 2023

(51) Int. Cl. G06Q 30/0241; G06F 3/04845; G06F 3/0486; G06F 16/22

(52) U.S. Cl. CPC G06Q 30/0276; G06F 3/04845; G06F 3/0486; G06F 16/2228

(57) ABSTRACT

Techniques are provided herein for increased processing efficiencies in the end-to-end creative offering process. Namely, a uniform ingest process for creative assets yields uniformity across creative providers. Further, centralized ingest of campaign information and creative assets bridges independent systems involved in the creative offering process. In this manner, creative processing tasks, from creative ingest and quality control, to activation with the ad decisioning service and active creative/campaign reporting may be facilitated by a uniform central source of truth. This may result in increased processing efficiencies and reduced processing delay in offering creative assets, which, in turn, may increase revenues generated from the offered creative assets.

### BACKGROUND

The present disclosure relates generally to digital content (e.g., advertisement) scheduling and provision services. More specifically, the present disclosure relates to a centralized creative gateway that facilitates end-to-end digital content offering functionalities from digital content ingest all the way to digital content rendering reporting.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In digital advertising, advertisers provide content providers and/or advertising management services with content (e.g., advertisements (“ads”) referred to herein also as “creatives”) to be served in one or more campaign and/or ad slots (“placements”) as part of a booked ad campaign. As used herein, an ad campaign is a set of ads/creatives that work together to promote a product or service, oftentimes targeting a particular market or placements within particular digital content.

These creatives are oftentimes sourced from a number of different advertisers. Unfortunately, however, the method of provisioning creatives varies from advertiser to advertiser, typically resulting in customized ingest procedures for many different advertisers. This leads to significant processing complexities and inefficiencies.

Further, once ingested, complex processes, typically involving numerous independent systems, are performed to activate creative placements within offered digital content. For example, the creatives and their associated metadata, such as an associated Video Ad Serving Template (VAST) tag, may undergo quality control (QC) processes to ensure suitability for provision to content provision platforms via a QC system. A separate service may provide an ad operations team visibility to campaigns to enable campaign fulfillment. Yet another service, an ad decisioning service (e.g., FreeWheel), using different metadata, may determine when creatives should be presented within content for active campaigns. Because of the independent nature of these systems, inefficiencies, such as data mis-matches, duplicative work, and manual human errors may result in additional processing efforts, delaying creative/campaign offerings, increasing monetary expenses, reducing scalability, and, in some cases, introducing undesirable association errors. Further, because of the independent nature of these systems, end-to-end management and tracking of creatives/campaigns has been virtually impossible, instead relying on piecemeal reporting via numerous different channels. As may be appreciated, all of these factors result in significant monetary risk, as revenues are dependent upon timely and accurate creative offerings. Accordingly, new techniques that streamline the end-to-end creative offering process are needed.

### BRIEF DESCRIPTION

Embodiments provided herein aim to increase processing efficiencies in the end-to-end creative offering process, by providing process uniformity across creative providers and bridging each of the independent systems involved in this process. In this manner, creative processing tasks, from creative ingest and quality control, to activation with the ad decisioning service and active creative/campaign reporting may be facilitated with relative ease, from a single central location, using uniform processes. This may result in increased processing efficiencies and reduced processing delay in offering creatives, which, in turn, may increase revenues generated from the offered creatives.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings. The patent or application file contains at least one drawing executed in color. Copies of this patent or patent application publication with color drawing(s) will be provided by the Office upon request and payment of the necessary fee.

FIG. 1 is a schematic diagram of a system that includes a creative gateway service to facilitate end-to-end creative processing, in accordance with one or more embodiments of the present disclosure;

FIG. 2 is a system diagram, illustrating a particular implementation of a system for end-to-end creative processing via a creative gateway service, in accordance with one or more embodiments of the present disclosure;

FIG. 3 is a flowchart, illustrating processes for end-to-end creative processing, in accordance with one or more embodiments of the present disclosure;

FIG. 4 is a schematic diagram, illustrating a Creative Assets Library graphical user interface (GUI) of the creative gateway service, in accordance with one or more embodiments of the present disclosure;

FIG. 5 is a schematic diagram, illustrating a Claiming Dialog Box of the Creative Assets Library GUI of FIG. 4, in accordance with one or more embodiments of the present disclosure;

FIG. 6 is a schematic diagram, illustrating a Campaign Library GUI of the creative gateway service, in accordance with one or more embodiments of the present disclosure;

FIG. 7 is a schematic diagram, illustrating filtering and customization via the Campaign Library GUI of FIG. 6, in accordance with one or more embodiments of the present disclosure;

FIG. 8 is a schematic diagram, illustrating a Launch Doc Generation GUI for a campaign, in accordance with one or more embodiments of the present disclosure;

FIGS. 9-11 are schematic diagrams, illustrating Launch Doc creation via the creative gateway, associating creatives with a particular campaign, in accordance with one or more embodiments of the present disclosure;

FIGS. 12A and 12B (collectively FIG. 12) are schematic diagrams, illustrating Creative Asset Details GUIs, in accordance with one or more embodiments of the present disclosure;

FIG. 13 is a schematic diagram, illustrating a Weighting/Flighting Instructions GUI of the creative gateway, in accordance with one or more embodiments of the present disclosure;

FIGS. 14A and 14B (collectively FIG. 14) are schematic diagrams of a process for appending pixels to a creative, in accordance with one or more embodiments of the present disclosure; and

FIG. 15 is a schematic diagram, illustrating the Launch Doc Generation GUI of FIG. 8, after the Launch Doc is populated and ready for saving, in accordance with one or more embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

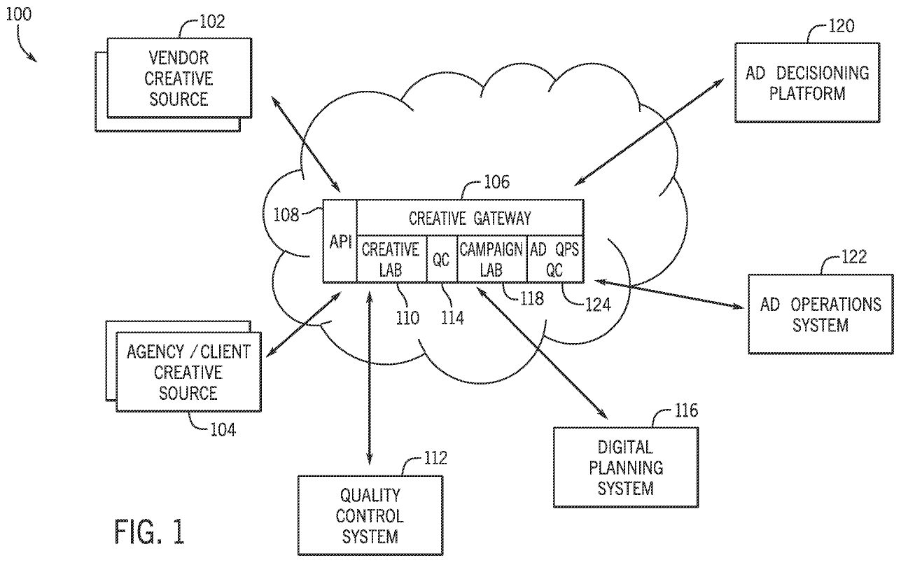

Turning now to the drawings, FIG. 1 is a schematic diagram of a system 100 that includes a creative gateway service to facilitate end-to-end creative processing, in accordance with one or more embodiments of the present disclosure. As illustrated, in FIG. 1, a number of different entities are involved in the end-to-end processing of a creative. For example, in system 100, different sources (e.g., Vendor Creative Source(s) 102 and Agency/Client Creative Source(s) 104) may submit creatives for presentation with digital content. The Vendor Creative Source(s) 102 may include remotely served assets (e.g., creatives and/or associated creative metadata) wrapped in Video Ad Serving Template (VAST) tags that provide metadata corresponding to the creative. The agency/client creative source(s) 104 may provide first party/site served creatives, which may be video files and trafficking instructions to be served by the content provider (e.g., via the content-provider providing transcoding and generation of a Uniform Resource Locator (URL) to access the site served creative). As mentioned above, creative sources oftentimes have supplied creatives in divergent manners, in different languages, and/or with different metadata, creating non-uniformity in ingesting and other downstream creative processing.

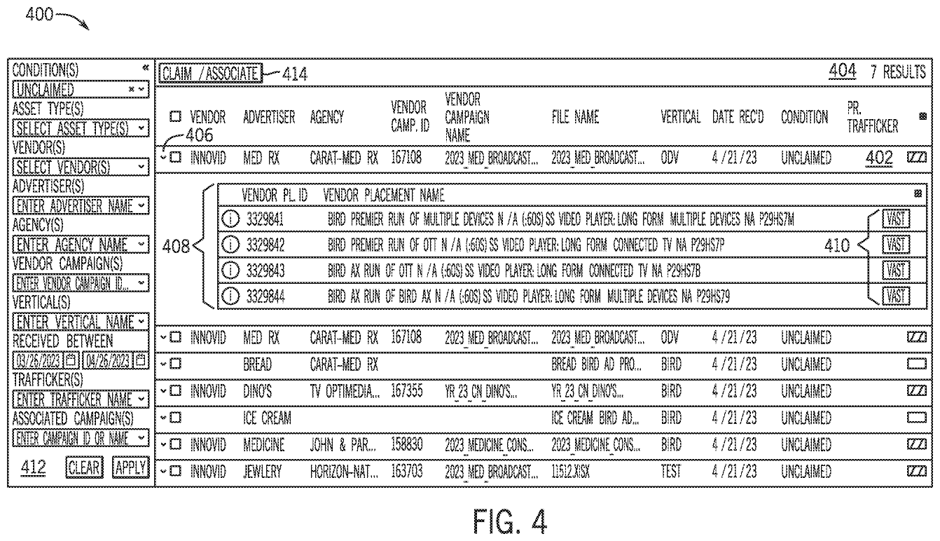

Accordingly, to avoid this non-uniformity, a centralized creative gateway 106 service is provided. The creative gateway 106 may include one or more exposed application programming interface(s) (API(s)) 108 that enable creative sources (e.g., Vendor Creative Source 102 and/or Agency/Client Creative Source 104) to submit creatives for ingest to the creative gateway 106 in a uniform manner, with uniform/expected metadata, and to a uniform location (e.g., a datastore of the creative gateway 106). The ingested creatives may be viewed via a creative library 110 GUI, as will be discussed in more detail with regard to FIG. 4.

Information supplied from the creatives sources via the API(s) 108 may include, for example, a vendor name, vertical, advertiser, agency, identifier, creative name, creative identifier, filename, vendor placement name, ad format, tag, ad-ID/Industry Standard Coding Identification (ISCI), and a video download link. Further, an indication of: a manner of tracking impression(s), quartiles, click through, weight, flight start, flight end, additional research pixels, vendor campaign name, vendor campaign identifier, research vendors, research identifiers, duration, and dimensions may also be provided.

Additionally, a quality control system 112 may be tasked with testing quality of the creatives and their associated metadata. This may help to ensure that suitable quality requirements for presentation of the creative are met prior to offering the creative for provision with digital content. The creative gateway 106 may facilitate quality control via the quality control system 112 by including a quality control interface 114 that provides creatives to the quality control system 112 for quality control, upon particular trigger conditions (e.g., upon the creative being ingested into creative gateway 106, upon the ingested creative being assigned to a campaign, etc.) In this manner, the quality control by the quality control system 112 may be triggered without reliance on human interaction, resulting in new timing efficiencies.

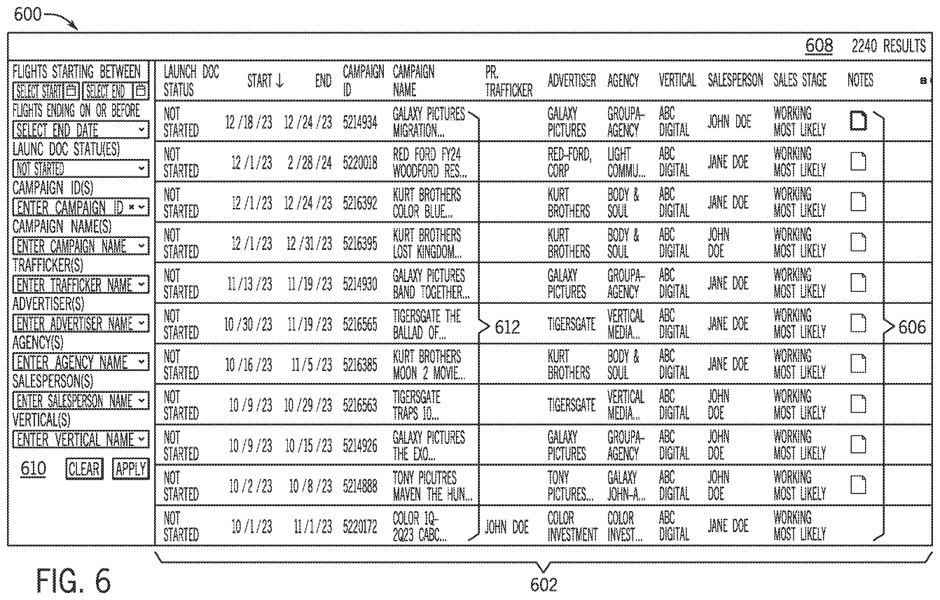

Further, an order management system (e.g., digital planning system 116) may supply campaign/deal information for prior, active, and/or upcoming campaigns and/or deals. This information may include particular targets for a particular set of creatives along with other information about the campaign. The creative gateway 106 may take in this campaign/deal information and may present campaign information via a campaign library 118 GUI, which will be discussed in more detail with respect to FIG. 6.

The creative gateway 106 may facilitate association of particular creatives with particular campaigns, enabling the creatives to be used in placements associated with a particular active campaign. The creative gateway 106 may communicatively couple with an ad decisioning platform 120 (e.g., an ad server), indicating the creatives associated with particular active campaigns. In turn, the ad decisioning platform 120 may provide informed creative placement during subsequent playback of digital content that includes ad slots for the campaign.

An ad operations team may be tasked with ensuring that ad campaigns are running smoothly (e.g., remain active, progressed to an expected number of impressions, etc.). Because the creative gateway 106 is coupled to each of the entities providing a portion of the end-to-end creative processing, the ad operations systems 122 may access pertinent ad operations quality control information from a single location; namely, an ad operations quality control 124 GUI of the creative gateway 106. For example, the ad operations quality control 124 GUI may provide an indication of creative playback rates, impressions actuals of campaigns, status of the campaigns, etc.

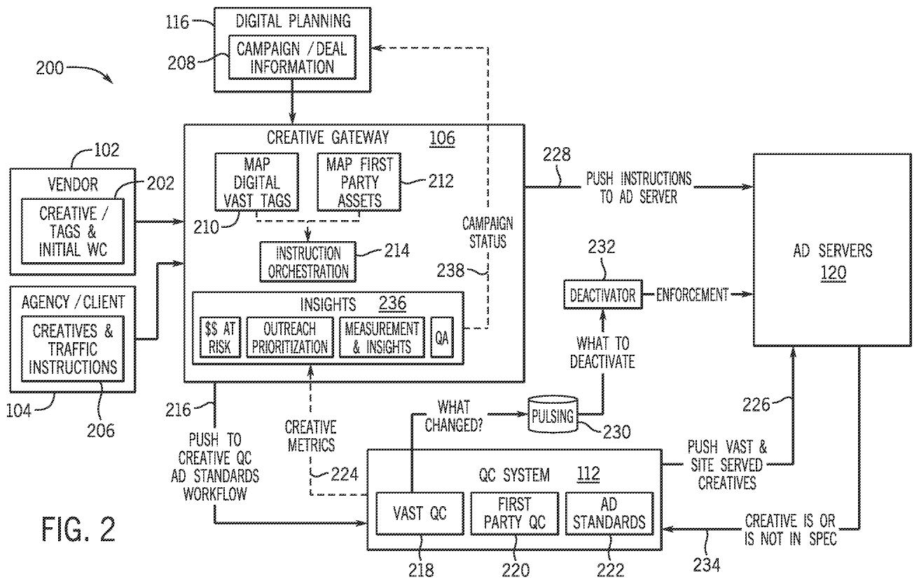

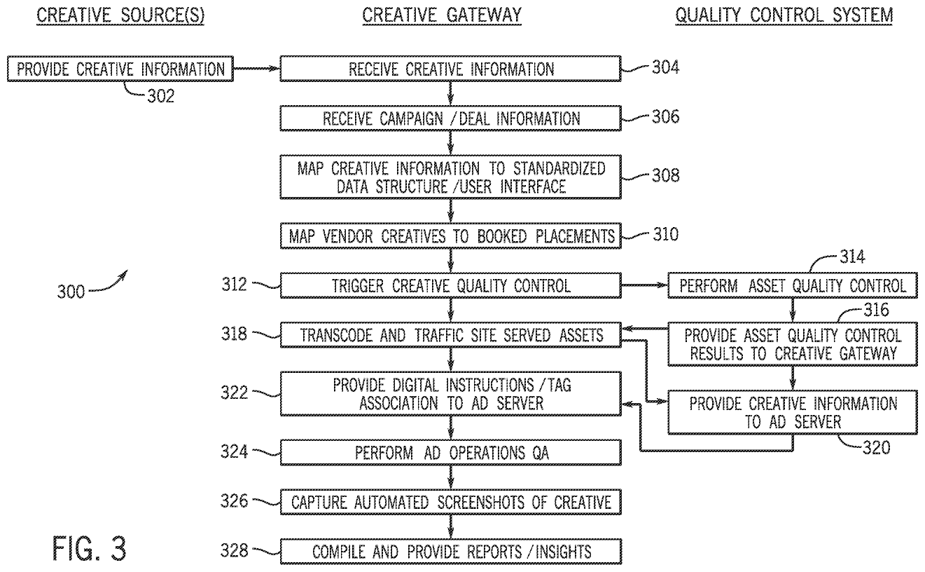

FIG. 2 is a system diagram, illustrating a particular implementation of a system 200 for end-to-end creative processing via a creative gateway 106, in accordance with one or more embodiments of the present disclosure. FIG. 3 is a flowchart, illustrating processes 300 for end-to-end creative processing, in accordance with one or more embodiments of the present disclosure. For simplicity, these figures will be discussed together.

As discussed above, different creative sources (e.g., Vendor Creative Source(s) 102 and Agency/Client Creative Source(s) 104) may provide creatives for presentation with digital content (block 302 of FIG. 3). Here, Vendor Creative Source(s) 102 may provide creatives 202 (e.g., initially quality controlled creatives and associated tags (e.g., VAST tags)) to the creative gateway 106. Agency/Client Creative Source 104 may provide creatives 206 (e.g., creative and associated traffic instructions) to the creative gateway 106. The provided creatives are received by the creative gateway (block 304).

Further, as illustrated, the digital planning system 116 may supply campaign/deal information for prior, active, and/or upcoming campaigns and/or deals to the creative gateway 106. The creative gateway 106 may receive and ingest this information (block 306).

Though the creative submissions may provide somewhat different data, the submissions may be received by the creative gateway 106 via one or more APIs of the creative gateway 106, enabling the creative gateway to ingest the submitted creatives in a uniform manner independent of traditional human subjective mapping/input processes. For example, during ingest, the creative gateway 106 may map and store creatives, creatives' metadata, and/or the received campaign/deal information 208 in a common/unified manner (e.g., in a common set of expected data fields/data structure within a data store), thus facilitating storage of creatives in a common data store and generation of a common GUI or set of GUIs for presenting ingested creatives, creative metadata, and/or campaign information (block 308). The mapping procedures are illustrated in block 210 of FIG. 2, relating to mapping received digital VAST tags into a common data structure and block 212 of FIG. 2, relating to mapping first party/site served assets (e.g., creatives and/or creative metadata received as a file) into a common data structure. As mentioned above, the data fields of the data structure may include: a vendor name, vertical, advertiser, agency, identifier, creative name, creative identifier, filename, vendor placement name, ad format, tag, ad-ID/Industry Standard Coding Identification (ISCI), and a video download link. Further, an indication of: a manner of tracking impression(s), quartiles, click through, weight, flight start, flight end, additional research pixels, vendor campaign name, vendor campaign identifier, research vendors, research identifiers, duration, and dimensions may also be provided.

At block 310, as part of the instruction orchestration 214, the creative gateway 106 may map the ingested creatives to one or more campaigns and/or placements (e.g., indicated in the campaign/deal information 208). As may be appreciated, because the creatives 202 and 206 and campaign/deal information 208 are ingested into common data structures and/or into common data fields, efficient mapping may occur. In some embodiments, a creative/campaign association GUI may enable a user to associate creatives with particular campaign placements (e.g., via a drag and drop of a particular creative to a campaign and/or particular campaign placement). In some embodiments, machine learning (ML) or other artificial intelligence (AI) techniques may be used to automatically associate creatives with particular content placements. For example, the ML may be trained based upon known creative and campaign/campaign placement matches based upon certain patterns of commonality between titles and/or other metadata associated with the creative, campaign, and/or placement.

The campaign/deal information 208 may include, for example: an order identifier, an order name, a buying agency, a primary advertiser, a campaign start date, a campaign end date, a net order value, total impressions, a primary salesperson, an owner, an order version, a number of line items, a sales team, a sales stage, a line item identifier, a placement name, a creative start date, a creative end date, special instructions, do not run dates, a primary trafficker, an indication of impressions, a net unit cost, a net cost, and/or a billable third party. The line item identifier may be used by the creative gateway 106 to map creatives ingested via the creative gateway 106 to the ad decisioning platform 120 (e.g., the ad decisioning platform 120 specific identifier).

At block 312, the creative gateway 106 may trigger creative quality control (e.g., without human request to do so). Specifically, as illustrated in FIG. 2, at arrow 216, an electronic indication of the creative and/or creative metadata is pushed into the quality control system 112, informing the quality control system 112 to begin quality control of the creative and/or creative metadata.

The quality control system 112 may then perform the quality control procedures for the assets (block 314). Specifically, the quality control system 112 may perform quality control on: the VAST tags (block 218), the first party/site served assets (block 220), and whether the creatives and/or creative metadata meet ad standards (e.g., whether the creatives meet the standards of the associated content playback services) (block 222).

While the quality control procedures may perform quality control on directly sold creatives/creative placements via received VAST tags, the quality control process may also quality control programmatic creatives where the creatives may not be ingested through the typical vendor submission and/or order management processes. To do this, the creative gateway 106 may receive programmatic creative tags from the QC system 112, which may receive the programmatic creative tags from the ad server/ad decisioning platform 120. For example, these programmatic tags may be submitted for quality control via the quality control system 112. The quality control results may e provided to creative gateway 106 for reporting and/or additional workflow functionality.

As indicated by arrow 224, asset quality control results/metrics for both direct order and programmatic assets may be provided back to creative gateway 106 (block 316). This enables creative gateway 106 to provide an indication of the asset quality control results/metrics via its own centralized GUIs and/or alerts.

Creative Gateway 106, as part of the instruction orchestration 214, for example, may provide an indication ingested assets available for transcoding and/or trafficking (block 318). For example, the creative gateway may trigger transcoding processes of site served assets into a particular format, store the transcoded assets in a data store, and traffic the transcoded assets by generating and providing, for use in a placement, a URL or other location identifier to the transcoded assets.

To do this, creative gateway 106 may trigger robotic process automation (RPA) bots to perform the transcoding and trafficking. For example, the RPA bots may generate a launch doc (e.g., instructions on placements for particular creatives), cause the transcoding of the creative, provide the location of the transcoded content (e.g., the URL) to the ad decisioning platform 120 along with placement identifiers (e.g., received from the digital planning system 116 in the campaign/deal information 208). Upon receipt of an ad decisioning platform 120 specific identifier for the creative from the ad decisioning platform 120, this identifier may be incorporated, by creative gateway 106, into the launch doc.

As illustrated by arrow 226, at block 320, QC system 112 may provide creative information (e.g., for creatives that pass quality control) to the ad server/ad decisioning platform 120. In this manner, the ad decisioning platform 120 may use creative information in determining ad decisioning for ad requests for placements received at the ad decisioning platform 120. The creative information may include the VAST tags (e.g., for Vendor Creative Source(s) 102 provided creatives 202) and/or trafficking URLs or other location information (e.g., generated at block 318) (e.g., for agency/client 104 provided creatives 206). In return, the ad server/ad decisioning platform 120 may provide an ad decisioning platform 120 specific identifier, indicating an identifier that is used by the ad decisioning platform 120 to identify the creative. These identifiers may be provided by the QC system 112 to creative gateway 106, enabling creative gateway 106 associations with the ad decisioning platform 120 specific identifier.

As indicated by arrow 228, at block 322, digital instructions and tag associations are provided to the ad server/ad decisioning platform 120. The digital instructions and tag associations may provide information that enables the ad server/ad decisioning platform 120 to serve particular creatives (e.g., provide particular creative URLs) for playback, in accordance with particular campaign parameters. For example, a campaign may specify that a particular creative may be placed in ad slots of a particular piece of content, which may be indicated in the provided digital instructions and/or tag associations. Creative gateway 106 may also trigger creative/placement associations in the ad server/ad decisioning platform 120 via this provided information.

Upon ingest of a creative and/or during an active campaign that is associated with the creative, the quality control system 112, via the pulsing engine 230, may periodically look for changes to the creative to determine whether the changes result in the creative no longer being suitable for presentation in a campaign. For example, the frames per second (fps), inserted pixel, signal-to-noise ratio, coloring, etc. of the creative may be changed to fall outside of a parameter specified by the ad standards (block 222). Upon identifying that a creative is unsuitable for presentation, an electronic signal may be sent to the deactivator 232, which provides an electronic command to the ad server/ad decisioning platform 120 to halt use of unsuitable creative in subsequent ad placements (e.g., until a subsequent re-activation command is received, etc.). The pulsing results may also be provided along with the creative identifiers (e.g., including the ad decisioning platform 120 specific identifier) to creative gateway 106, enabling creative gateway 106 to maintain this information for subsequent reporting and to associate the ad decisioning platform 120 specific identifier with other identifiers of the creative.

As indicated by arrow 234, for programmatic creatives, the ad server/ad decisioning platform 120 may provide an indication of the creatives, enabling the QC system 112 to determine whether campaign creatives meet the specifications of the ad server/ad decisioning platform 120 and/or the content provision systems. This information (along with QC results of other creatives) may be propagated to back to creative gateway 106, enabling ad operations quality control of the campaign (block 324). In some embodiments, automated screenshots of served creatives may be captured and provided to and/or stored within creative gatway 106 as proofing and/or a verification that a campaign is executed properly (block 326). Creative gateway 106 may include a graphical user interface, enabling clients associated with particular creatives and/or campaigns to provide and/or view the creatives and/or campaigns actively being served via these captured screenshots.

Creative gateway 106 may generate reports and/or provide these insights via a GUI (block 328). For example, an ad operations team may access campaign status GUIs within creative gateway 106, which may present insights 236, including for example, revenue at risk (e.g., due to deactivated creatives and/or campaigns), outreach prioritization, measurements and insights (e.g., with respect to particular creatives and/or campaigns), and quality assurance metrics associated with particular creatives and/or campaigns, such as an activation status, realized impressions, presentation errors (e.g., when a content presentation service refused playback of the creative), etc. to identify active, inactive, and/or deactivated campaigns and/or creatives along with quality control results of quality control system 112. As illustrated by arrow 238, in some embodiments, campaign information/status may be provided back to the digital planning system 116, enabling remote campaign quality control/monitoring. In some embodiments, such campaign information/status may include an aggregation/analysis indicating revenue by agency, workload distribution for ad operations team members, etc.

Having discussed the functionality of creative gateway 106, the discussion now turns to particular graphical user interfaces (GUIs) and GUI interactions facilitated by creative gateway 106. FIG. 4 is a schematic diagram, illustrating a Creative Assets Library graphical user interface (GUI) 400 of the creative gateway 106 service, in accordance with one or more embodiments of the present disclosure.

The Creative Assets Library GUI 400 provides an interface to view and/or edit information associated with creatives ingested by creative gateway 106. As illustrated, for ingested creatives, the GUI 400 may provide rows of top-level 402 (e.g., also referred to as “asset sheets”) providing information pertaining to the creative. For example, in the depicted example, this information includes: a vendor, advertiser, agency, vendor campaign identifier, vendor campaign name, filename, vertical, received date, claiming status, and primary trafficker identifier. The expander affordance 404 may enable additional items to be displayed in the top-level 402 (e.g., additional data supplied by the vendor and/or agent during the creative ingest).

A details affordance 406 associated with the top-level 402, when selected, may result in rendering details associated with the top-level 402. In the depicted example, a nested list 408 of associated placements (e.g., vendor placement identifiers and vendor placement names) is provided, along with affordances 410 to display associated VAST tags are provided.

The rows of top-levels 402 may be adjusted by applying filter criteria via the filtering bar 412. For example, the rows of top-levels 402 may be filtered based upon claiming status, asset type(s), vendor(s), advertiser(s), agency(s), vendor campaign(s), vertical(s), a date received range, trafficker(s), associated campaign(s), etc.

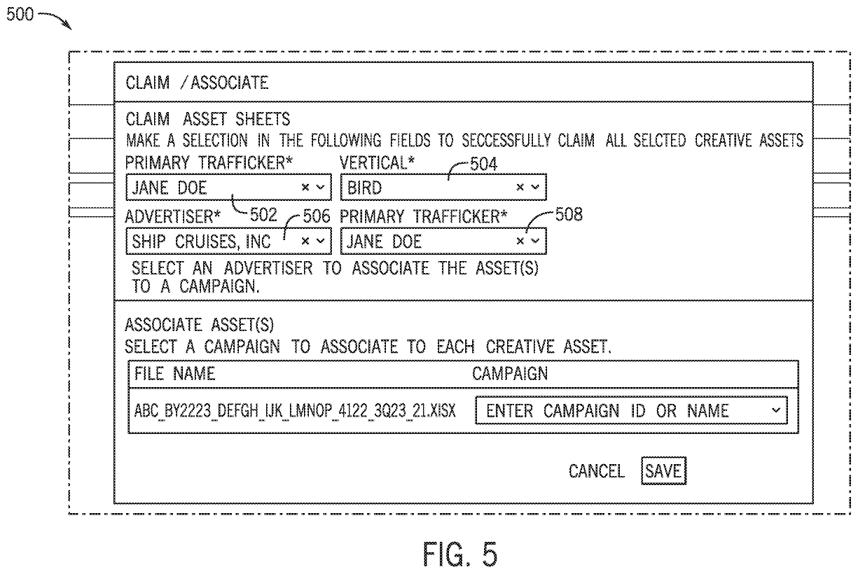

As creatives are ingested into creative gateway 106, the asset sheets may be set to an “unclaimed” claiming status. The claim/associate affordance 414, when selected, facilitates claiming and otherwise associating entities to the asset sheets. FIG. 5 is a schematic diagram, illustrating a Claiming Dialog Box 500 that is rendered in response to selection of the claim/associate affordance 414 of FIG. 4, in accordance with one or more embodiments of the present disclosure. The Claiming Dialog Box 500 enables traffickers (e.g., a primary and/or secondary trafficker) to be associated with the asset sheet via one or more affordances (e.g., primary trafficker affordance 502). By enabling traffickers to claim asset sheets, additional accountability may be provided with respect to the assets. Further, enabling asset and campaign associations, enables ease of reporting and/or use in other features in the creative gateway 106, such as asset and/or campaign filtering criteria. Additionally, particular verticals may be specified via the vertical affordance 504.

A particular advertiser may be associated with the asset sheet via the advertiser affordance 506. Further, an agency may be associated with the asset sheet via agency affordance 508. In addition, a campaign may be associated with the asset sheet via the campaign affordance 510. The data values provided as options in the affordances 502-508 may be sourced from one system (e.g., an ad management platform, such as Operative One) across all asset sheets. In this manner, vendors using different data values, such as Vend1 vs Vendor1 may all conform to data values of a single system of record. The mapping between vendor-specific data values and the system of record data values may be automatically mapped by creative gateway 106 using pattern recognition or other AI from historical training data regarding the vendor's and/or other vendors' historical submissions.

Having discussed the Creative Assets Library GUI 400, the discussion now turns to the Campaign Library. FIG. 6 is a schematic diagram, illustrating a Campaign Library GUI 600 of the creative gateway 106 service, in accordance with one or more embodiments of the present disclosure. The Campaign Library GUI 600 provides a list of campaigns 602 ingested into creative gateway 106. For each campaign, the list of campaigns 602 may provide aggregated campaign information. For example, in the depicted embodiment, the aggregated campaign information includes: a launch doc status, a campaign start date, a campaign end date, a campaign identifier, a campaign name, a primary trafficker, an advertiser, an agency, a vertical, a salesperson, a sales stage, and a notes affordance 606 that, when selected, enables viewing and/or editing of notes of an associated campaign.

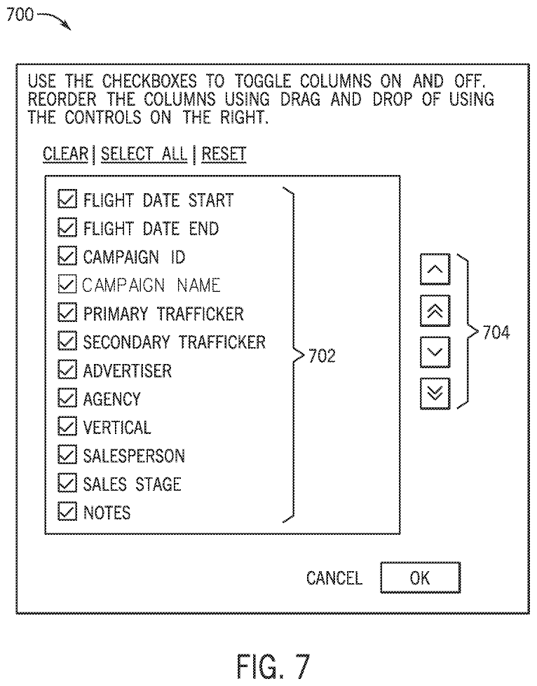

The information provided in the list of campaigns 602 may be customized by selecting the expander affordance 608. For example, in response to the expander affordance 608 being selected, the campaign information customization dialog box 700 of FIG. 7 may be displayed. As illustrated in FIG. 7, selection affordances 702 enable selection of particular information to be presented in the list of campaigns 602 of FIG. 6. Further, the ordering affordances 704 enable the particular information to be ordered in a customized ordering in the Campaign Library GUI 600.

Returning to FIG. 6, the list of campaigns 602 may be filtered to provide only campaigns meeting filter criteria selected via the filter bar 610. In the current embodiment, for example, the filter bar 610 may include filter criteria such as: flight start ranges, flight ending ranges, launch doc status, campaign identifiers, campaign names, trafficker(s), advertiser(s), agency(s), salesperson(s), and/or vertical(s).

Further, a launch doc affordance 612 may be provided for each campaign in the list of campaigns 602. When selected, the launch doc affordance may result in presentation of a Launch Doc GUI 800 for the associated campaign.

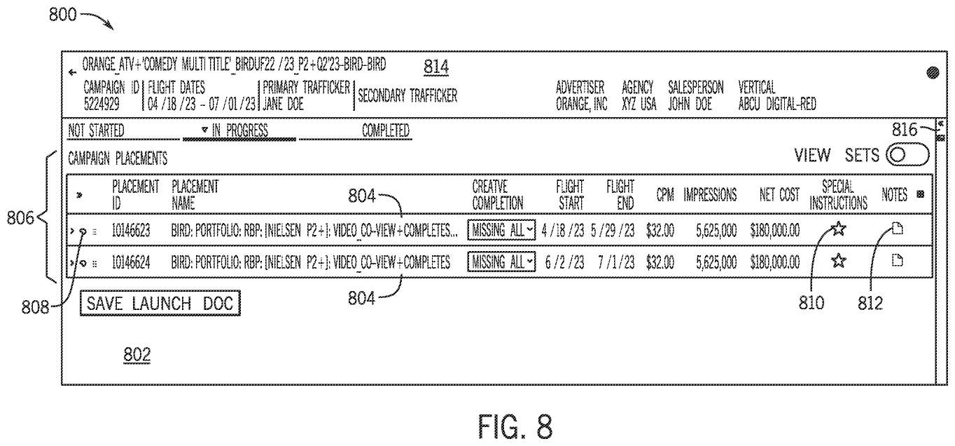

FIG. 8 is a schematic diagram, illustrating a Launch Doc GUI 800 for a campaign, in accordance with one or more embodiments of the present disclosure. In an initial state, the launch doc canvas 802 of Launch Doc GUI 800 may present a shell launch doc with basic information about the campaign without the campaign placements. For example, the campaign information may include a campaign identifier, flight date range, primary trafficker, secondary trafficker, advertiser, agency, salesperson, and/or a vertical. This information may be all or a portion of the campaign/deal information 208 ingested into creative gateway 106 from the digital planning system 116.

As illustrated, after presentation of the shell, campaign placements 804 (e.g., represented by campaign placement rows) may be populated in the Campaign Placements section 806 of the launch doc. As illustrated, the campaign placements 804 may include information pertaining to the campaign placements, such as an indication of a placement identifier, a placement name, a creative completion status, a flight start date, a flight end date, a cost indication (e.g., cost per 1000 impressions (CPM)), a number of impressions, and a net cost. Additionally, the Launch Doc GUI 800 may include a color coding affordance 808 that enables users to select a particular color coding for a particular campaign placement 804. The special instructions affordances 810 enable a user to view special instructions received (e.g., from digital planning system 116) on a per campaign placement basis in the Launch Doc GUI 800.

It may be important to facilitate communications between users of the Launch Doc GUI 800. For example, quality control and ad operations teams may desire to inform each other of various information pertaining to the campaign and/or campaign placements. The notes affordances 812 enable a user to input notes on a per campaign placement basis. When selected, color coding, special instructions, and/or notes are associated with the particular campaign placement 804 in a data store coupled to the Launch Doc GUI 800. In addition to providing notes at the campaign placement 804 level, notes affordance 814, when selected, enables a user to add notes at the overall campaign level. These notes will be associated with the campaign identifier in the data store coupled to the Launch Doc GUI 800. In some embodiments, the notes may be provided in the other GUIs of the creative gateway 106, such as the Creative Assets Library GUI 400 of FIG. 4, the Campaign Library GUI 600 of FIG. 6, and or other reporting GUIs of creative gateway 106.

In some embodiments, a change log may also be provided in creative gateway 106. The change log may track and display changes made within creative gateway 106 as users make the changes. In this manner, progress/changes, from asset intake to campaign maintenance may be monitored, tracked, and reported for clear understanding of the changes made via creative gateway 106.

It may be desirable to see and/or associate creative assets to the campaign placements 804. Accordingly, a creative assets drawer affordance 816, when selected, may cause rendering of a creative assets drawer that provides information about the ingested vendor/agency-supplied creative assets.

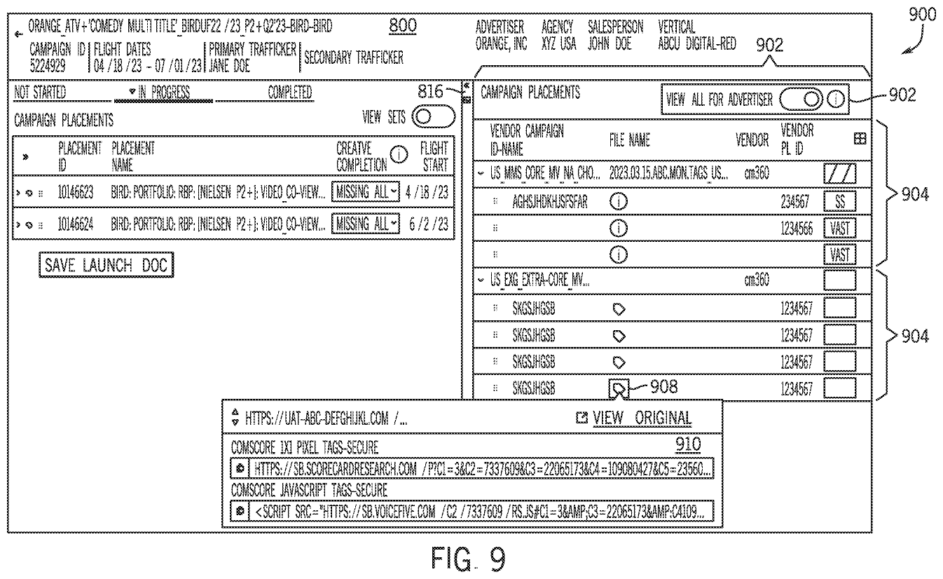

FIGS. 9-11 are schematic diagrams, illustrating progressions 900, 1000, and 1100, respectively, of the Launch Doc GUI 800 during association of creative assets with a particular campaign, in accordance with one or more embodiments of the present disclosure. As illustrated in progression 900, upon selecting the creative assets drawer affordance 816, a creative assets drawer 902 is rendered in the Launch Doc GUI 800. The creative assets drawer 902 enables users to see creative assets 904 associated with the current campaign (e.g., from the Creative Assets Library of FIG. 4). An advertiser affordance 906 enables all creative assets associated with the advertiser of the current campaign to be displayed in the creative assets drawer 902.

As illustrated and discussed here, the creative assets 904 may include site served assets and/or third-part served (e.g., VAST tag) assets. Additionally, the pixel affordance 908, when selected, enables pixel information associated with particular creative assets 904 to be displayed. For example, as illustrated, the pixel information may be provided in a pixel information dialog box 910 that provides an indication of pixels associated with the particular creative asset 904.

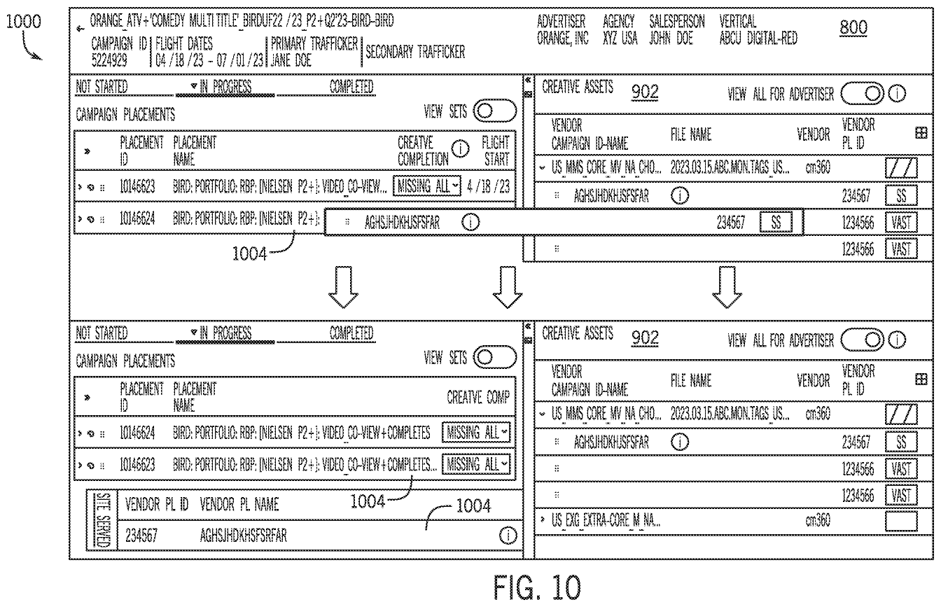

As illustrated in portion A of progression 1000 of FIG. 10, creative assets 1002 may be associated with particular campaign placements 1004. In the current embodiment, a user may perform a drag and drop operation of the creative asset 1002 in the creative assets drawer 902 to the particular campaign placement 1004. However, in other embodiments, machine learning and/or other artificial intelligence (AI) may be used to identify patterns in naming information of the vendor/agent-provided creative asset information with naming information campaign/deal information 208, even when inconsistent names are used due to being supplied by varied entities. In some embodiments, in response to a creative being inserted into the launch doc, an indication of the creative's insertion into the launch doc may be provided. For example, the inserted creative may be greyed out within the creative assets drawer 902, providing a helpful indication that the creative has already been inserted into the launch doc.

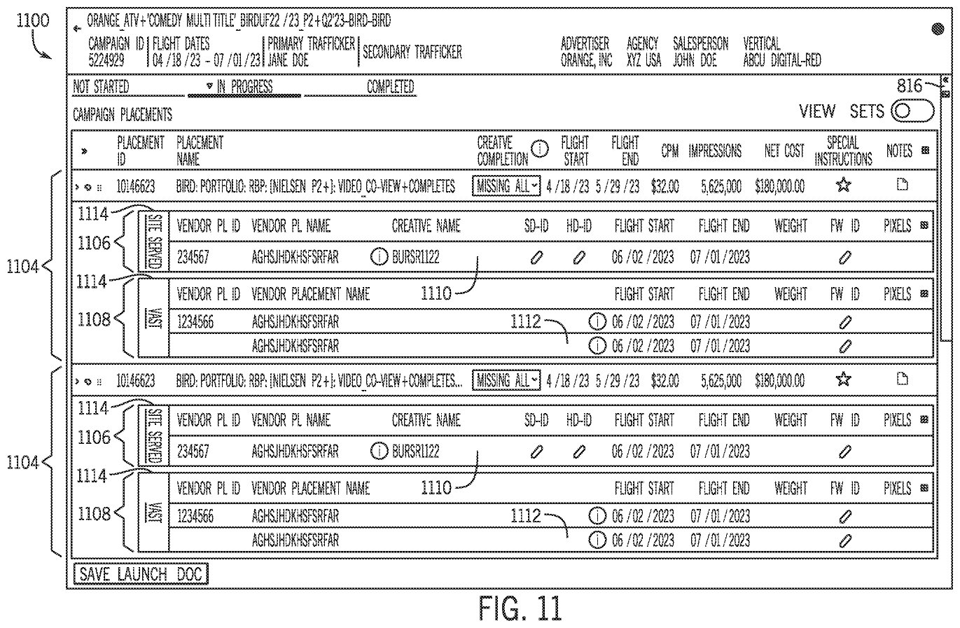

In portion B of progression 1000, creative asset 1002 is associated with the campaign placement 1004. In the current embodiment, the association is illustrated by the nesting of the creative asset 1002 under the campaign placement 1004. Progression 1100 of FIG. 11 illustrates a Launch Doc 1102 after creative association. The Launch Doc 1102 includes campaign placements 1104 with associated site served creative assets 1106 and VAST tag creative assets 1108.

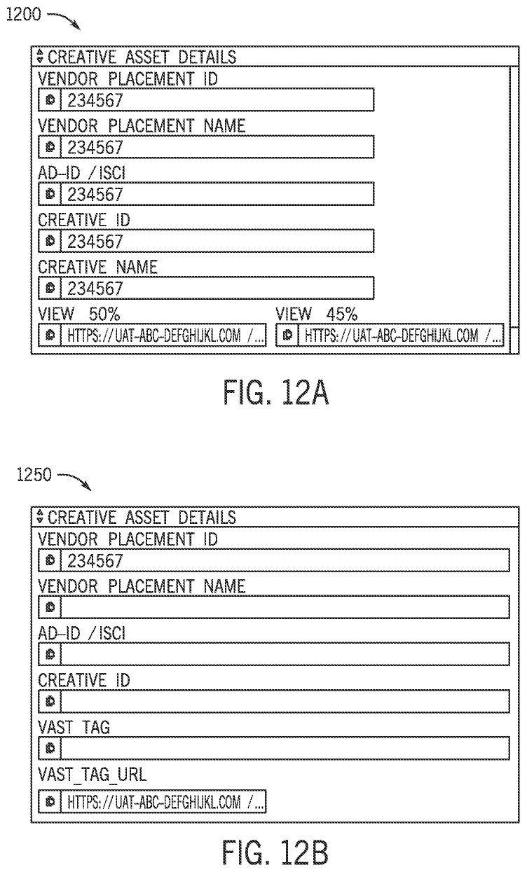

Creative asset details of a particular site served creative asset may be displayed by selecting a corresponding details affordance 1110. FIG. 12A illustrates a creative asset details dialog box 1200 that may be rendered in respond to selection of the details affordance 1110. As illustrated, the creative asset details dialog box 1200 may provide various detail regarding a corresponding site served creative asset. For example, here, the creative asset details dialog box 1200 provides a vendor placement identifier, a vendor placement name, an ad identifier/ISCI, a creative identifier, a creative name, and various links/locations/URLs associated with the creative asset (e.g., indicating where the creative asset is located for access).

Creative asset details of a particular VAST tag creative asset may be displayed by selecting a corresponding details affordance 1112. FIG. 12B illustrates a creative asset details dialog box 1250 that may be rendered in respond to selection of the details affordance 1112. As illustrated, the creative asset details dialog box 1250 may provide various detail regarding a corresponding VAST tag creative asset. For example, here, the creative asset details dialog box 1250 provides a vendor placement identifier, a vendor placement name, an ad identifier/ISCI, a creative identifier, a creative identifier, a VAST tag, and the links/locations/URLs indicated in the VAST tag (e.g., indicating where the creative asset is located for access).

As may be appreciated, some of the information from the creative asset details dialog boxes 1200 and/or 1250 (e.g., the vendor placement identifier, the vendor placement name, the ad identifier/ISCI, the creative identifier, the creative name, and/or the VAST tag) may be supplied to the ad server/ad decisioning platform 120 to facilitate implementation of the campaign. Further, the links/locations may be provided to the QC system 112 to enable quality control of the creative assets and/or campaign. In some embodiments, the provision may be facilitated via copy affordances that enable a user to copy information from the creative assets details dialog boxes 1200 and/or 1250 for pasting into these systems. In some embodiments, the creative gateway 106 may automatically provide this information (e.g., via API calls or other integration) to these systems as the information is acquired and/or associated with campaign placements.

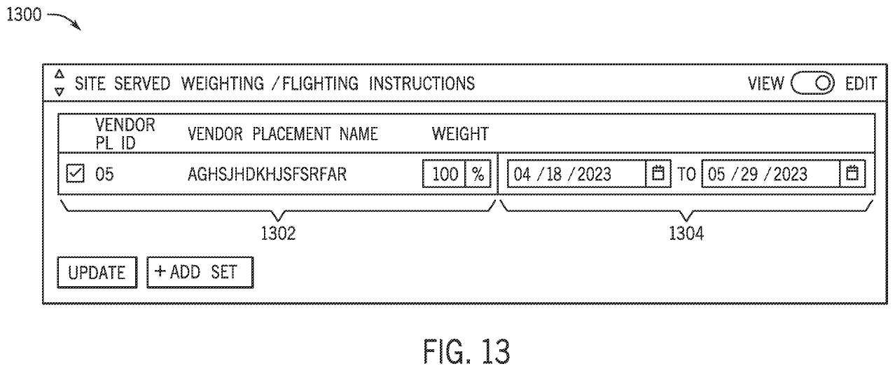

Returning to FIG. 11, each of the site served creative assets 1106 and VAST tag creative assets 1108 may be rendered with an affordance 1114 that, when selected, enables a user to set weighting and/or flighting instructions. For example, FIG. 13 is a schematic diagram, illustrating a Weighting/Flighting Instructions GUI 1300 of the creative gateway that may be rendered upon selection of the affordance 1114, in accordance with one or more embodiments of the present disclosure. The Weighting/Flighting Instructions GUI 1300 may include a weight input 1302 enabling a user to input a weight that indicates a relative amount of presentation that the current creative asset should be presented with respect to the pool of creative assets associated with the campaign placement. Further, the Weighting/Flighting Instructions GUI 1300 may include flighting range inputs 1304 that enable a user to selected flight start and/or end dates. Upon selection of the Update affordance 1306, the inputted weights and flighting ranges may be associated and saved in a data store of the creative gateway 106. In some embodiments, in addition to and/or in lieu of providing the Weighting/Flighting Instructions GUI 1300, a drag and drop feature may be provided, enabling instructions to be dragged and dropped into creative gateway 106.

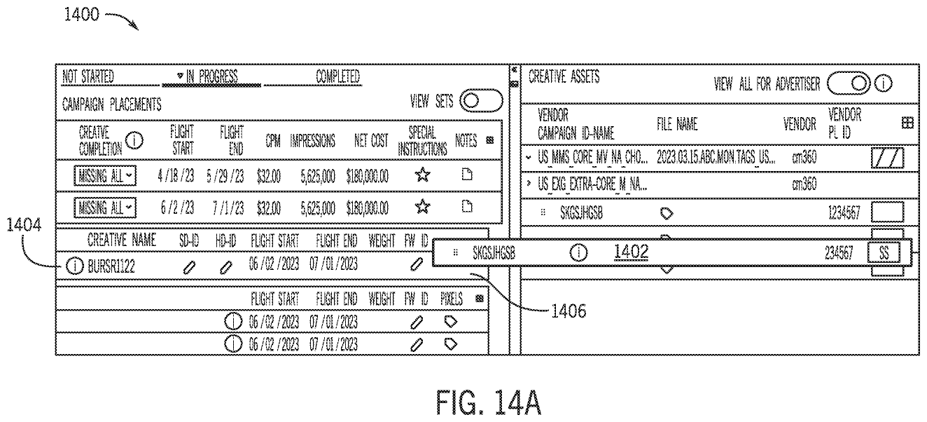

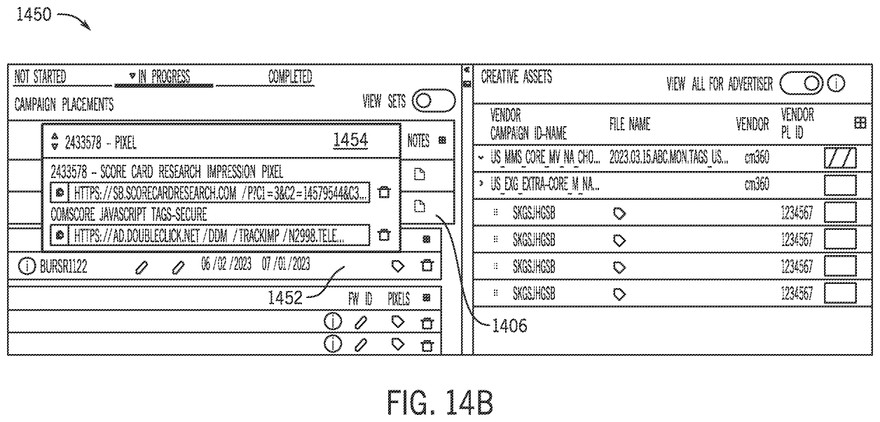

Another edit that may be made to the Launch Doc 1102 is to add pixels to the campaign's creative assets 1106 and/or 1108. FIGS. 14A and 14B (collectively FIG. 14) are schematic diagrams, indicating progressions 1400 and 1450, respectively, to append a pixel 1402 to a creative asset 1404, in accordance with one or more embodiments of the present disclosure. As illustrated in progression 1400, pixel 1402 may be dragged and dropped to a pixel area 1406 of the creative asset 1404 to append the pixel 1402 to the creative asset 1404.

As illustrated in FIG. 14B, once the pixel 1402 is appended, a pixel indication 1452 is rendered in the pixel area 1406, indicating that a pixel is associated with the creative asset 1404. Upon selection of the pixel indication 1452, an indication of the appended pixels may be provided. For example, as illustrated, a pixel dialog box 1454 may be displayed, providing the appended pixel information.

As described herein, in some embodiments, drag and drop insertion may be afforded to other insertion tasks as well. For example, in some embodiments, users may drag assets (e.g., images) to corresponding tags, similar to the pixel insertion affordances discussed above.

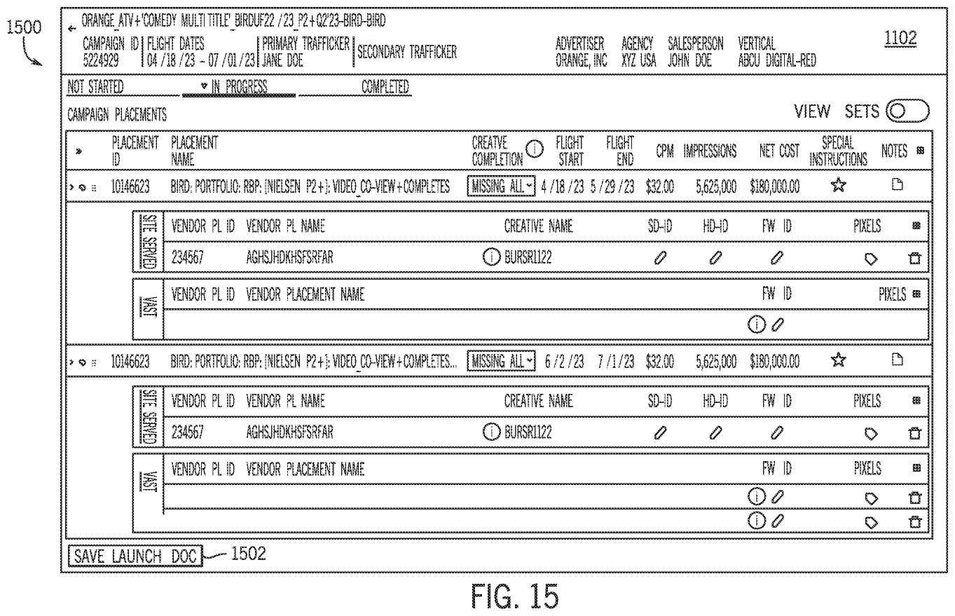

Once populated and/or edited, the launch doc 1102 may be saved. FIG. 15 is a schematic diagram, illustrating an example 1500 of the Launch Doc GUI 800 of FIG. 8, after the launch doc 1102 is populated and ready for saving, in accordance with one or more embodiments of the present disclosure. To save the launch doc 1102, the user may select the save affordance 1502, which results in unsaved selections of those discussed herein being saved in a data store of the creative gateway 106. In this manner, each of the entities involved in implementing campaigns and/or creative assets may have a single source of truth. The launch docs may be used to inform campaign implementation, generate reports, facilitate quality control, and provide an overall picture of campaign status. Further, launch docs may be stored in a common/centralized data store, providing predictability in the launch doc location and ease of access to the launch docs.

Reporting functionality regarding assets and campaigns provided in creative gateway 106 provides significant granularity. For example, in some embodiments, the launch doc may provide an indication of missing creative completions for each placement. This may provide an indication of whether all placements have an associated creatives, which, in some instances, may be required. In some embodiments, the creative asset library may, for every asset sheet, provide a usage indicator (e.g., a modal window) that provides an indication of what campaign(s)/placement(s) the asset sheet is associated with. Further, the campaign library may provide asset sheet counts, indicating how many times and/or where corresponding asset sheets are used in other launch docs. These features may enable tracking and/or reduce error rates related to undesirable duplication of use. As mentioned above, the reporting functionality may also include a change log that tracks updates made in the system and may provide a timestamped indication of each change that occurs.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A tangible, non-transitory, computer-readable medium, comprising computer-readable instructions that, when executed by one or more processors of one or more computers, cause the one or more computers to:
receive creative asset information from a creative asset source;
in response to receiving the creative asset information, ingest a creative asset by storing a record of the creative asset in an associated data store, wherein the record is stored in a data structure that it is standardized for all creative asset sources providing creative asset information to the one or more computers, and wherein the record comprises the creative asset information;
receive campaign information from a digital planning system different than the creative asset source;
generate a launch doc, indicating an association of creative assets with campaign placements, by merging the creative asset information with the campaign information; and
render the launch doc via a launch doc graphical user interface (GUI).

2. The tangible, non-transitory, computer-readable medium of claim 1, comprising computer-readable instructions that, when executed by one or more processors of one or more computers, cause the one or more computers to:
merge the creative asset information with the campaign information using machine learning that identifies patterns in naming nomenclature in the creative asset information, the campaign information, or both to map the creative asset information with the campaign information.

3. The tangible, non-transitory, computer-readable medium of claim 1, comprising computer-readable instructions that, when executed by one or more processors of one or more computers, cause the one or more computers to:
merge the creative asset information with the campaign information by:
identifying a drag and drop operation of a graphical creative asset indication in the launch doc GUI to a graphical campaign placement indication in the launch doc GUI; and
associating a portion of the creative asset information pertaining to the graphical creative asset indication with a portion of the campaign information pertaining to the graphical campaign placement indication.

4. (canceled)

5. The tangible, non-transitory, computer-readable medium of claim 1, comprising computer-readable instructions that, when executed by one or more processors of one or more computers, cause the one or more computers to:
in response to ingesting the creative asset, trigger automatic quality control of the creative asset by providing an indication of the creative asset to a quality control system.

6. The tangible, non-transitory, computer-readable medium of claim 5, comprising computer-readable instructions that, when executed by one or more processors of one or more computers, cause the one or more computers to:
receive an indication that the automatic quality control of the creative asset passed; and
in response to the indication that the automatic quality control of the creative asset passed, provide digital instructions comprising an indication of the creative asset to an ad decisioning service; or
receive an indication that the automatic quality control of the creative asset failed; and
in response to the indication that the automatic quality control of the creative asset failed, provide a failure indication via a GUI that provides a creative asset status; or
both.

7. The tangible, non-transitory, computer-readable medium of claim 1, comprising computer-readable instructions that, when executed by one or more processors of one or more computers, cause the one or more computers to:
in response to ingesting the creative asset, trigger transcoding of the creative asset and traffic the transcoded creative asset.

8. The tangible, non-transitory, computer-readable medium of claim 7, comprising computer-readable instructions that, when executed by one or more processors of one or more computers, cause the one or more computers to:
trigger the transcoding of the creative asset and the trafficking of the transcoded creative asset by triggering a robotic process automation (RPA) script.

9. The tangible, non-transitory, computer-readable medium of claim 1, comprising computer-readable instructions that, when executed by one or more processors of one or more computers, cause the one or more computers to:
track and report statistics of a campaign associated with generated launch doc, creative quality control status, campaign quality control status, or any combination thereof.

10. The tangible, non-transitory, computer-readable medium of claim 1, comprising computer-readable instructions that, when executed by one or more processors of one or more computers, cause the one or more computers to:
render a claim GUI that enables a user to claim a primary trafficker, advertiser, vertical, agency, or any combination thereof of an associated creative asset;
receiving, via the claim GUI an assignment input of an assigned primary trafficker, assigned advertiser, assigned vertical, assigned agency, or any combination thereof; and
store the assignment input as an association of the associated creative asset.

11. The tangible, non-transitory, computer-readable medium of claim 1, comprising computer-readable instructions that, when executed by one or more processors of one or more computers, cause the one or more computers to:
generate and render a creative asset library, comprising a graphical list of all ingested creative assets or a specified portion of the ingested creative assets.

12. The tangible, non-transitory, computer-readable medium of claim 11, wherein the ingested creative assets comprise both site served creative assets and video ad serving template (VAST) tag creative assets.

13. The tangible, non-transitory, computer-readable medium of claim 1, comprising computer-readable instructions that, when executed by one or more processors of one or more computers, cause the one or more computers to:
generate and render a campaign library, comprising a graphical list of all ingested campaigns or a specified portion of the ingested campaigns.

14. The tangible, non-transitory, computer-readable medium of claim 13, comprising computer-readable instructions that, when executed by one or more processors of one or more computers, cause the one or more computers to:
for each of the ingested campaigns rendered in the campaign library, render a launch doc affordance that, when selected, results in rendering a launch doc corresponding to the associated ingested campaign.

15. The tangible, non-transitory, computer-readable medium of claim 14, comprising computer-readable instructions that, when executed by one or more processors of one or more computers, cause the one or more computers to:
cause rending of a creative assets drawer comprising at least a portion of creative assets of a creative assets library to be displayed with campaign placements of the ingested campaigns.

16. The tangible, non-transitory, computer-readable medium of claim 15, comprising computer-readable instructions that, when executed by one or more processors of one or more computers, cause the one or more computers to:
receive a pixel addition indication comprising a drag and drop of a pixel in the creative assets drawer to a pixel area of a creative asset associated with the campaign placements; and
in response to receiving the pixel addition indication, append the pixel to the creative asset associated with the campaign placements.

17. A system, comprising:
a quality control system configured to receive an indication of a creative asset and, in response to receiving the indication of the creative asset, perform automated quality control on the creative asset;
a creative gateway, configured to:
receive creative asset information from a creative asset source;
receive campaign information from a digital planning system different than the creative asset source;
merge the creative asset information with the campaign information to assign the creative asset information to a campaign placement described in the campaign information to generate a centralized record of the creative asset information assigned to the campaign placement; and
in response to receiving the creative asset information:
ingest the creative asset by storing a record of the creative asset in an associated data store, wherein the record is stored in a data structure that is standardized for all creative asset sources providing creative asset information to the creative gateway, and wherein the record comprises the creative asset information; and
provide the indication of the creative asset to the quality control system, the indication of the creative asset comprising at least a portion of the creative asset information.

18. The system of claim 17, wherein the creative gateway is configured to store screenshots of the creative asset being served during an active campaign via a graphical user interface (GUI).

19. A computer-implemented method, comprising:
receiving an indication of a creative asset via creative asset information from a creative asset source;
in response to receiving the creative asset information, ingesting the creative asset by storing a record of the creative asset in an associated data store, wherein the record is stored in a data structure that is standardized for all creative asset sources providing creative asset information, and wherein the record comprises the creative asset information;
receiving campaign information from a digital planning system different than the creative asset source;
mapping the creative asset to a campaign placement indicated in the campaign information;
providing digital instructions, a tag association, or both of the mapped creative asset to the campaign placement to an ad server; and
receiving and reporting campaign status updates from the ad server regarding the creative asset in the campaign placement.

20. The computer-implemented method of claim 19, comprising:
receiving a first indication of a first creative asset via first creative asset information from a vendor creative asset source;
receiving a second indication of a second creative asset via second creative asset information from an agency creative asset source; and
ingesting the first creative asset and the second creative asset using a common data structure type.
